(19) United States
(12) Patent Application Publication
(10) Pub. No.: US 2012/0273508 A1
(43) Pub. Date: Nov. 1, 2012

(54) FITTING FOR A PLASTIC-LINED TANK, AND METHOD FOR MANUFACTURING A TANK INCORPORATING SAME

(76) Inventors: Peter G. HASELOH, Kindersley (CA); Kirste Ann MANUEL, Dartmouth (CA)

(21) Appl. No.: 13/460,353

(22) Filed: Apr. 30, 2012

Related U.S. Application Data
(60) Provisional application No. 61/480,329, filed on Apr. 28, 2011.

(51) Int. Cl. B65D 25/00; B05D 7/22

(52) U.S. Cl. 220/694; 427/231

(57) ABSTRACT

In a method for manufacturing a plastic-lined metal tank, a permanent fitting having a flow passage is secured within an opening in the tank wall. A lower portion of the fitting has fitting anchorage means and protrudes into the tank interior. A temporary plug is disposed within the fitting's flow passage. A plastic material is introduced into the tank, which is then multi-axially rotated by a rotational molding apparatus while introducing heat to melt the plastic material. The molten plastic is deposited to form a liner over the inner surface of the tank shell and over exposed surfaces of the fitting and temporary plug. After the plastic liner has cooled and solidified, the temporary plug is removed from the fitting, and the liner is trimmed as required to allow fluid flow through the fitting's flow passage.

### CROSS-REFERENCE TO RELATED APPLICATIONS

This application claims the benefit of U.S. Provisional Application No. 61/480,329, filed on Apr. 28, 2011, and said earlier application is incorporated herein by reference in its entirety for continuity of disclosure.

### FIELD OF THE DISCLOSURE

The present disclosure relates in general to methods for making plastic-lined metal storage tanks with leak-tight external fittings, and to fittings and related accessories for use in association with such methods.

### BACKGROUND

It is commonly desirable to line metal storage tanks with internal plastic liners to protect the metal tank shells from corrosion or other chemical reactions. However, such tanks invariably require one or more metal fittings (such as fluid inlet and outlet fittings) extending through and rigidly connected to the tank wall (such as by welding). Leakage between the fittings and the plastic liner is a persistent problem, resulting in liquid migration at the interface between the two dissimilar materials. This leakage is due primarily to the fact that the metal used for the tank shell and fittings and the plastic used for the liner typically have significantly different coefficients of thermal expansion, making it difficult or impossible to achieve a leak-tight bond between the liner and the shell. This would be little or no problem for lined tanks used in a temperature-controlled environment. However, this is rarely a practical option in industries where lined tanks are commonly used, such as the oil and gas industry.

Past attempts to design fittings that would provide a leak-tight seal with a plastic liner, such as by using O-ring seals, barbed fittings, and spun welded plastic fittings, have not resulted in success. These efforts have failed primarily because the fittings were installed after the plastic liner had been formed inside the tank, and therefore did not seal properly.

For the foregoing reasons, there is a need for methods of providing leak-tight making plastic-lined metal storage tanks with leak-tight external fittings. There is a further need for fittings and accessories for use with such methods.

### BRIEF SUMMARY

The present disclosure teaches methods for manufacturing a plastic-lined metal storage tank with fittings extending through the shell of the metal tank so as to produce a substantially leak-tight seal at the interfaces between the fittings and the plastic liner, and between the plastic liner and the inner surfaces of the tank shell. Methods in accordance with the disclosure may be advantageously adapted for use with tanks made from plain steel, stainless steel, or aluminum, but are not restricted to tanks made from those or any other particular metals.

The present disclosure also teaches embodiments of fitting components and assemblies suitable for use in conjunction with the disclosed methods for manufacturing plastic-lined metal tanks.

Accordingly, in one aspect the present disclosure teaches a fitting assembly comprising:
a metallic fitting having an upper end, a lower end, and a perimeter wall defining a flow passage extending through the fitting between said upper and lower ends of the fitting; with the fitting further having fitting support means for supporting the fitting in an opening in a metal shell (such as the shell of a metal tank) such that a lower portion of the fitting will extend through the opening in the shell; plus fitting anchorage means associated with the lower portion of the fitting, for anchoring the fitting to a plastic liner applied to the lower surface of the metal shell;
a plug having an upper end, a lower end, and a perimeter surface extending between the upper and lower ends of the plug, with the perimeter surface being configured to permit insertion of the plug into the fitting's flow passage through the upper end of the flow passage such that the lower end of the plug substantially closes off the lower end of the flow passage; and
plug retention means, for removably retaining the plug within the flow passage of the fitting.

In a preferred embodiment, the plug is generally cup-shaped, with an open-topped cavity bounded by the perimeter wall and a bottom closure. The plug preferably (but not necessarily) has an annular flange that serves to limit the depth to which the plug can be inserted into the fitting's flow passage. Optionally, an upper portion of the plug may be configured for engagement with a tool whereby the plug can be rotated relative to the fitting.

Also in a preferred embodiment, the perimeter wall of the fitting has a thickened upper portion extending radially outward, with a downward-oriented annular shoulder being formed at the lower end of the thickened upper portion to provide the fitting support means. The annular shoulder may be advantageously recessed into thickened upper portion to facilitate placement of the fitting within an opening in a tank shell.

The fitting anchorage means can be provided in the form of an annular flange projecting outward from a lower region of the fitting. However, this is by way of example only, and the fitting anchorage means could take a variety of different forms.

The plug retention means may be provided by way of male threading formed on the perimeter surface of the plug, and mating female threading formed in the wall of fitting within the flow passage, but this is by way of example only.

In one alternative embodiment, the plug is non-rotatably retained within the flow passage of the fitting by means of splines formed on the perimeter wall of the plug and engageable with mating grooves formed in the wall of fitting within the flow passage.

In another embodiment of the fitting assembly, the plug has an annular flange as described above, with the annular flange having an extended portion that will extend beyond the perimeter of the thickened upper portion of the perimeter wall of the fitting when the plug is disposed within the fitting's flow passage. One or more fastener holes are provided through the flange's extended portion for purposes described below. An annular groove is formed into the outer surface of the fitting's thickened upper portion. For purposes of this embodiment, the plug retention means can be provided in the form comprises a clamp plate having a cut-out shaped such that the clamp plate can slide laterally into the annular groove on the fitting. The clamp plate is provided with one or more fastener holes which are alignable with the one or more fastener holes in the extended portion of the plug's annular flange when the clamp plate is engaged within said annular groove, such that one or more fasteners can be installed in the aligned fastener holes in the annular flange and the clamp plate, thereby clamping the plug in place within the fitting and securing the clamp plate to the fitting.

Methods in accordance with the present disclosure are intended to be used in association with suitable rotational molding techniques, many of which will be known to persons skilled in the art. For example, U.S. Pat. No. 5,728,423 (Rogerson) discloses a method for forming plastic liners on the interior and exterior of metal tanks, containers, and pipes, using a rotational molding process. The amount of plastic that is put into a container for rotational molding determines the total wall thickness of the finished product. The thickness of the plastic liner is an important determining factor in the design of the fittings being installed into the metal tank shell. U.S. Pat. No. 4,705,468 (LeBreton) teaches a method for incorporating a metal fitting into a plastic tank liner formed by rotational molding. Methods in accordance with the present disclosure can be used in conjunction with molding processes and technologies such as those taught by Rogerson and LeBreton, but are not restricted to or limited by the use of those or any other particular molding processes and technologies. As well, molding processes and technologies suitable for use in association with methods taught herein do not exclude methods that may be developed in the future.

### BRIEF DESCRIPTION OF THE DRAWINGS

Embodiments in accordance with the present disclosure will now be described with reference to the accompanying Figures, in which numerical references denote like parts, and in which:

FIG. 1 is a cross-section through one embodiment of a temporary plug in accordance with the present disclosure, for use in association with a permanent fitting during the tank-lining process.

FIG. 1A is top view of the temporary plug shown in FIG. 1.

FIG. 2 is a cross-section through one embodiment of a permanent fitting in accordance with the present disclosure, adapted for mounting in an opening in a tank shell prior to lining the tank shell, and adapted to receive a temporary plug as in FIG. 1.

FIG. 2A is a top view of the permanent fitting shown in FIG. 2.

FIG. 3A is partial section through the shell of a metal tank, showing a permanent fitting as in FIG. 2 installed in an opening through the tank shell, with a temporary plug as in FIG. 1 installed in the permanent fitting, in preparation for application of an interior plastic liner.

FIG. 3B is a partial section through a tank-and-fitting assembly in FIG. 3A after application of an interior plastic liner.

FIG. 3C is a partial section through the tank-and-fitting assembly as in FIG. 3B after removal of the temporary plug from the fitting and after partial removal of the plastic liner to permit fluid flow through the fitting.

FIG. 4 is a cross-section through an alternative embodiment of a temporary plug in accordance with the present disclosure.

FIG. 4A is top view of the temporary plug shown in FIG. 4.

FIG. 5 is a cross-section through an alternative embodiment of a permanent fitting in accordance with the present disclosure.

FIG. 6 illustrates one embodiment of a clamp plate configured for use in conjunction with the temporary plug shown in FIGS. 4 and 4A and the fitting shown in FIG. 5.

FIG. 6A is an alternative variant of the clamp plate shown in FIG. 6.

FIG. 7 is an assembled view of the temporary plug in FIG. 4, the fitting in FIG. 5, and the clamp plate in FIG. 6.

FIG. 7A is cross-section through the assembly in FIG. 7.

### DETAILED DESCRIPTION

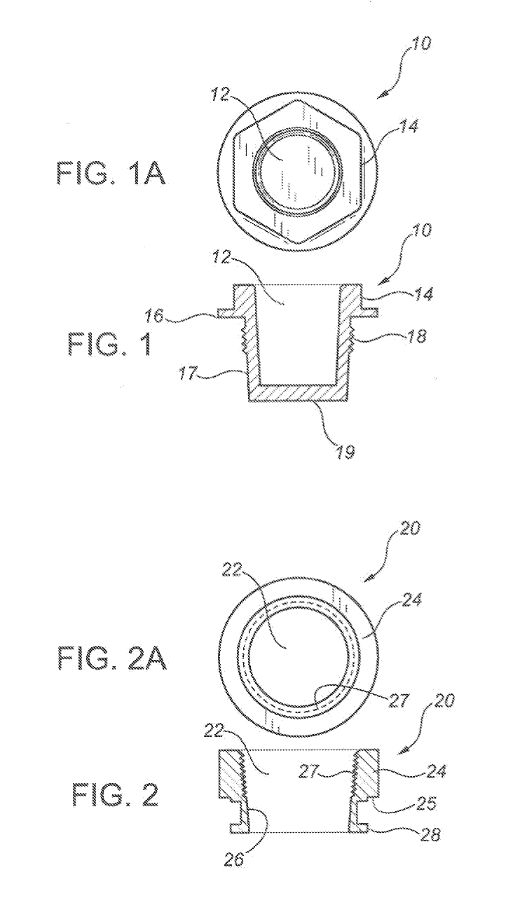

FIGS. 1 and 1A illustrate an embodiment of a temporary plug 10 in accordance with the present disclosure, for use in the installation of a fitting in the plastic-lined wall of a metal-shelled storage tank. In the illustrated embodiment, temporary plug 10 is generally cup-shaped, with an open-topped cavity 12 bounded by a perimeter wall 17 having a generally cylindrical or frustoconical outer surface, and by a bottom closure 19. A portion of perimeter wall 17 is provided with external (male) threading 18 for engagement with the mating internal (female) threading of a permanent fitting (as described later herein). Preferably, an annular flange 16 projects outward from an upper region of perimeter wall 17, above threading 18, with one purpose of annular flange 16 being to control the maximum depth to which temporary plug 10 can be inserted into a mating permanent fitting. However, the present disclosure is intended to encompass variants of temporary plug 10 that do not have an annular flange 16 as illustrated or otherwise.

A portion of perimeter wall 17 above threading 18 (and above flange 16 when present) may be fashioned in the form of a hex nut 14 or so as to form other means to facilitate rotation of temporary plug 10. By way of non-limiting example, cavity 12 in temporary plug 10 could be configured in the form of a socket (such as a square socket) for engagement by a suitable tool for rotation of temporary plug 10. In another exemplary variant, tool-engaging recesses or tool-engaging lugs could be formed in wall 17 within cavity 12 to facilitate rotation of temporary plug 10.

In preferred embodiments, temporary plug 10 is made from a non-metallic material, but this is not essential.

FIGS. 2 and 2A illustrate a metallic fitting 20 adapted to receive temporary plug 10 and for installation in the shell of a metal storage tank intended to receive an internal plastic liner. Fitting 20 has a perimeter wall 26 defining a generally cylindrical or frustroconical bore or flow passage 22, with flow passage 22 having internal (female) threading 27 configured for engagement with the external threading 18 on temporary plug 10. An annular flange 28 projects outward from perimeter wall 26 of fitting 20, for purposes described later herein.

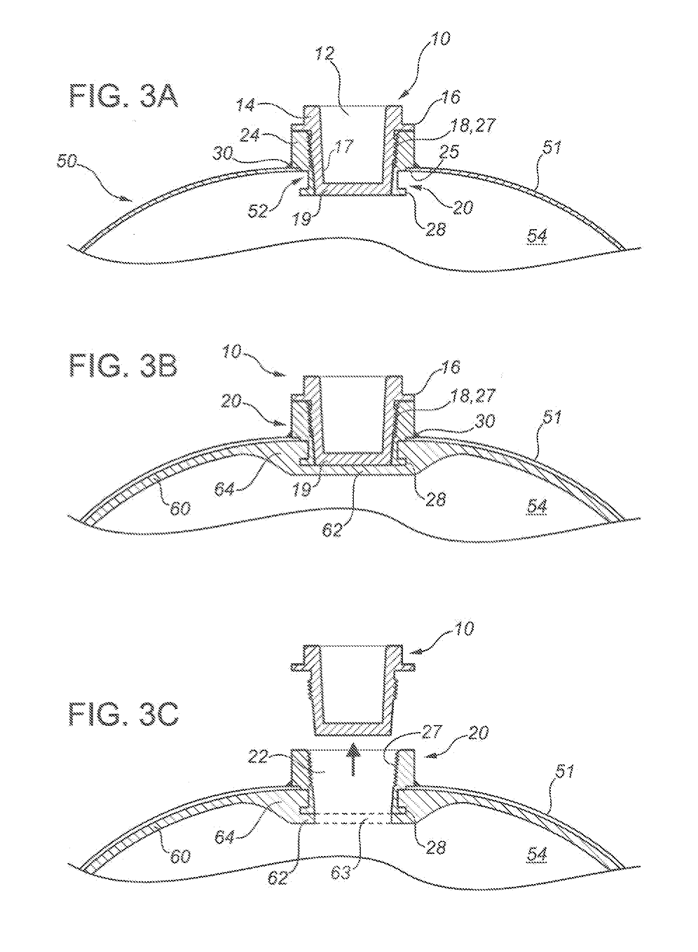

A thickened upper portion 24 of perimeter wall 26 projects radially outward with a downward-oriented annular shoulder 25 being formed at the lower end of thickened portion 24. In the illustrated embodiment, annular shoulder 25 is recessed into thickened upper portion 24 of perimeter wall 26 to facilitate centering of fitting 20 within an opening 52 through the shell 51 of a tank 50 as seen in FIGS. 3A, 3B, and 3C, and also facilitating the provision of a smooth transition between the inner surface of tank shell 51 and the lowermost surface of thickened portion 24. In variant embodiments, however, the lower surface of thickened portion 24 could be unrecessed, such that annular shoulder 25 is coextensive with the lower surface of thickened portion 24.

Although the illustrated embodiments provide for removable engagement or retention of temporary plug 10 with permanent fitting 20 by means of a threaded connection (i.e., external threading 18 on temporary plug 10 and internal threading 27 on fitting 20), the present disclosure is not limited to that particular means for removable engagement of these components. By way of non-limiting example, variants of temporary plug 10 could alternatively be removably engageable with fitting 20 by means of external splines formed on wall 17 of temporary plug 10 and engageable with mating grooves formed into the inner surface of perimeter wall 26 of fitting 20. In such alternative embodiments, temporary plug 10 would be inserted axially and non-rotatingly into flow passage 22 in fitting 20, and temporary plug 10 would preferably be provided with any suitable means to facilitate withdrawal of temporary plug 10 from fitting 20. Also in such alternative embodiments, the outer surface of perimeter wall 17 of temporary plug 10 and the inner surface of perimeter wall 26 of fitting 20 could be other than cylindrical or frustoconical (although those particular geometrical configurations may be preferable for optimal fluid flow through flow passage 22 in fitting 20).

FIGS. 3A, 3B, and 3C illustrate progressive stages in one embodiment of a method in accordance with the present disclosure for applying an internal plastic liner to a metal tank 50 with a fitting extending through the tank shell. Referring first to FIG. 3A, a fitting 20 as in FIG. 2 is positioned in an opening 52 formed in the metal tank shell 51, with annular shoulder 25 of fitting 20 supported on tank shell 51 around the perimeter of opening 52. Fitting 20 is made from the same kind of metal as tank shell 51 (or from a metallurgically compatible metal), such that fitting 20 can be welded to tank shell 51 as indicated by reference number 30. As may be seen in FIG. 3A, tank shell opening 52 must be large enough to allow annular flange 28 of fitting 20 to pass through and project into the interior 54 of tank 50. In turn, the diameter of annular shoulder 25 must be greater than the diameter of opening 52 in order for annular shoulder 25 to bear on tank shell 51. Either before or after fitting 20 is installed within tank shell opening 52, a temporary plug 10 as in FIG. 1 is removably disposed within flow passage 22 of fitting 20. Preferably (but not necessarily), temporary plug 10 will extend into flow passage 22 to the extent that its bottom closure 19 is substantially flush with the bottom surface of annular flange 28 of fitting 20.

Tank 50, with one or more fitting assemblies installed in corresponding openings 52 in tank shell 51, is then mounted in a rotational molding apparatus of any suitable type, and an appropriate amount of plastic material is introduced into the interior 54 of tank 50. In this context, the term “fitting assembly” is to be understood as denoting the combination of a fitting 20 and a temporary plug 10. In accordance with conventional rotational molding techniques, the plastic material inside tank 50 is heated (such as by hot air) while tank 50 is multi-axially rotated, such that the plastic melts and is deposited over the inner surface of tank shell 51, thereby forming a unitary plastic liner 60 on the inner surface of tank shell 51. At the same time, the plastic liner 60 will envelop those portions of the fitting assemblies that protrude into the interior 54 of tank 50, with localized thickening 64 of the plastic material around fittings 20, and with a portion 62 of liner 60 extending across the annular flange 28 of each fitting 20 and across the bottom closure 19 of each temporary plug 10, all generally as shown in FIG. 3B. In the process, annular flange 28 of fitting 20 becomes fully encased within plastic liner 60. The plastic-lined tank assembly is then allowed to cool, and the thickness of plastic liner 60 is measured. If necessary, additional plastic material can be introduced into the tank and the rotational molding process continued until plastic liner 60 is of desired or specified thickness.

Once the rotational molding process is complete, and the lined tank has been allowed to cool, the temporary plug 10 is unscrewed from each fitting 20. The liner portions 62 covering the bottom closures 19 of temporary plugs 10 can then be cut out or drilled out (as conceptually indicated by broken lines 63 in FIG. 3C) to allow fluid flow through flow passage 22 of fitting 20 and into the interior 54 of the now-lined tank 50.

Annular flange 28 is preferably formed integrally with fitting 20, but in variant embodiments could be a separate component welded or otherwise mounted to fitting 20. Fittings 20 coming within the scope of the present disclosure are not limited to embodiments having an annular flange 28 as illustrated and described herein, or in fact having an annular flange as such. The illustrated annular flange 28 serves as a means for facilitating physical anchorage of fitting 20 to liner 60 formed on shell 51 of tank 50. However, persons skilled in the art will readily appreciate such “fitting anchorage means” could be provided in a variety of other forms in lieu of an annular flange as illustrated. By way of non-limiting example, the fitting anchorage means in variant embodiments could comprise a plurality of circumferentially-spaced protrusions (of any suitable shape and configuration) extending radially outward from a lower region of perimeter wall 26 of fitting 20.

The specific configuration of fitting 20 may be adapted to suit particular design requirements or performance specifications, having due regard to the fact that the thickness of the finished plastic liner 60 will be influenced by the extent to which annular flange 28 projects or protrudes into the interior 54 of tank 50. If annular flange 28 (or other fitting anchorage means) protrudes either too far or too little into tank 50, the thickness of liner 60 over internally-protruding portions of fitting 20 may vary significantly from the liner thickness over the tank shell, in which case the desired cooling-induced shrink sealing of liner 60 around fitting 20 may be suboptimal. However, persons of ordinary skill in the art will have no difficulty achieving desired liner configurations and cooling-induced shrink-sealing characteristics using known calculation and/or trial-and-error methods that have been developed for use with rotational molding processes.

Fittings 20 will typically be thicker than the tank shell 51, and in some case considerably thicker. For this reason, the thinner metal of tank shell 51 will heat up more quickly than fittings 20, and as a result, plastic liner 60 will tend to be thicker on shell 51 than on fittings 20. In one alternative embodiment of the presently-disclosed method, this problem can be mitigated by making the temporary plugs 10 from a highly-conductive non-ferrous metal such as copper alloy or aluminum to enhance heat transfer to fittings 20 made of plain or stainless steel, for instance. By way of further example, if tank shell 51 and fittings 20 are made from aluminum, the differential heating problem can be mitigated by using comparatively thin-walled temporary plugs 10 made of steel.

The differential heating problem may be further or alternatively mitigated by forming non-ferrous temporary plugs 10 with cup-shaped cavities 12 as illustrated. This allows compressed air to be blown into cavities 12 to enhance heat transfer down to the bottom and sides of fittings 20. The use of non-ferrous temporary plugs 10 in conjunction with steel or stainless steel fittings 20, in conjunction with the circulation of compressed air into cavities 12 of temporary plugs 10 as appropriate, can thus help ensure that fittings 20 heat up at substantially the same rate as the thinner tank shell 51, due to the differences in thermal conductivity of the metals used.

Although it may be advantageous, for reasons including those outlined above, to form temporary plugs 10 with cavities 12 as illustrated, this feature is not essential. In variant embodiments, temporary plugs 10 could be essentially solid.

As previously noted, it is preferable for temporary plugs 10 to extend down to the bottom of fittings 20, with the bottom closure 19 of each temporary plug 10 substantially flush with the bottom surface of annular flange 28 of the associated fitting 20. This will ensure that fittings 20 do not fill with the plastic material. In addition, this reduces turbulence caused by changes in the direction of flow of the liquid plastic as it passes around annular protrusions of fittings 20. If the liquid plastic encounters abrupt changes of flow direction, particularly over short distances, porosity and localized thinning of the plastic liner can result. Such defects can cause leaks between the plastic liner and the metal tank shell.

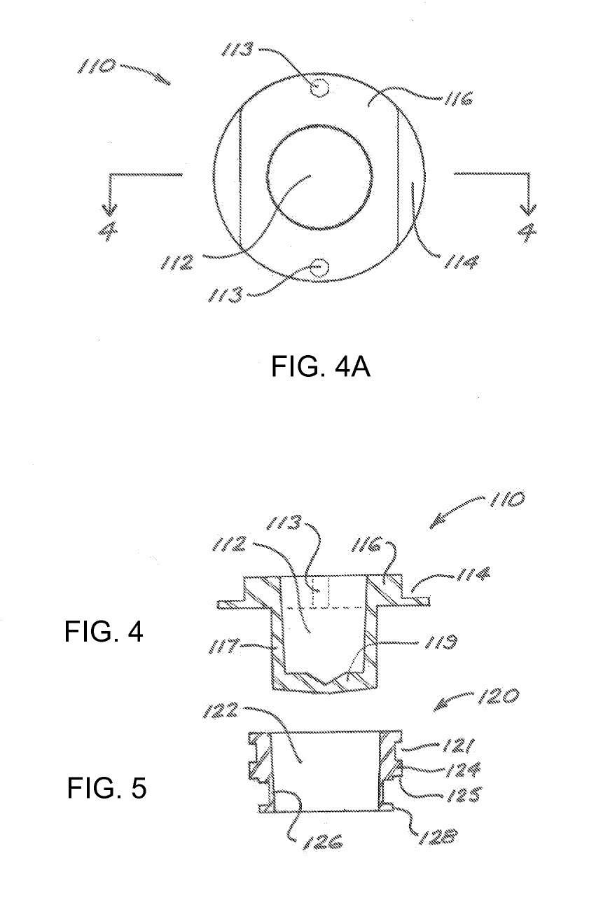

FIGS. 4 and 4A illustrate a temporary plug 110 in accordance with an alternative embodiment, and FIG. 5 illustrates a permanent fitting 120 in accordance with an alternative embodiment. (In FIGS. 4, 4A, and 5, numerical references to components or features of plug 110 and fitting 120 correspond to similar or analogous components or features of plug 10 and fitting 20 but with the addition of the prefix “1”.) The configuration of plug 110 is generally similar to that of plug 10 previously described but plug 110 has an unthreaded outer surface 111. In preferred embodiments, outer surface 111 will be cylindrical or frustoconical, but is not restricted to either of these geometric configurations; by way of non-limiting example, the configuration of outer surface 111 could alternatively be polygonal, ovate, or non-circularly curvilinear in cross-section). The configuration of fitting 120 is generally similar to that of fitting 20 previously described, but fitting 120 has an unthreaded perimeter wall 126 defining a flow passage 122 configured to removably receive temporary plug 110 in a close-tolerance fit.

Because plug 110 and fitting 120 are not threaded, alternative plug retention means will be provided for temporarily retaining plug 110 within fitting 120 during the tank lining process. In the illustrated embodiments, the plug retention means are provided by:
Forming fitting 120 with a groove 121 (or one or more functionally-equivalent recesses) machined or otherwise formed into the outer surface of thickened upper portion 124 of perimeter wall 126 of fitting 120, such that groove 121 will be exterior to tank 50 when fitting 120 has been mounted in an opening 52 in tank shell 51;
Providing one or more fastener holes 113 through flange 116 of plug 110, at a radius suitably larger than the outer radius of upper portion 124 of perimeter wall 126 of fitting 120; and
Providing, for each fitting 120, a clamp plate 40 having a suitably configured cut-out 42 and a suitable thickness 44 such that clamp plate 40 can be removably disposed within at least a portion of groove 121 in fitting 120, with clamp plate 40 having fastener holes 46 configured and located to receive fasteners inserted through fastener holes 113 in flange 116 of plug 110.

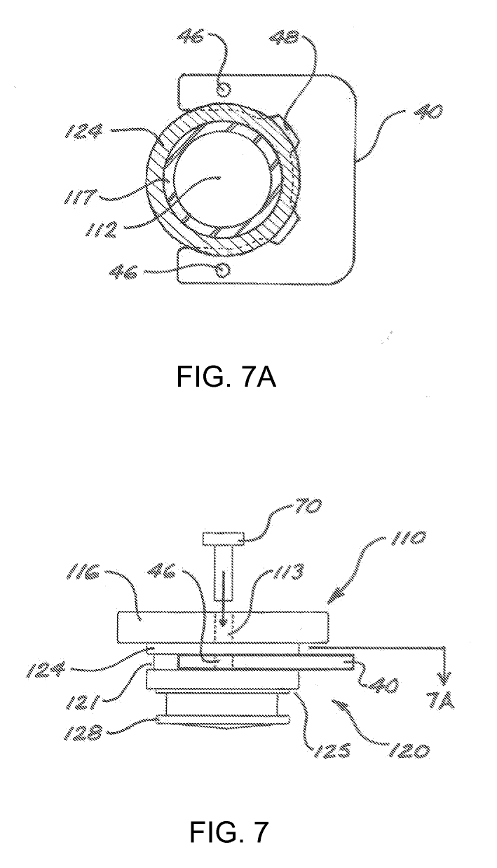

As illustrated in FIG. 7, when plug 110 is disposed within flow passage 122 of fitting 120, and clamp plate 40 is disposed within groove 121 in upper portion 124 of perimeter wall 126 of fitting 120 with fastener holes 46 in clamp plate 40 aligned with fastener holes 113 in flange 116 of plug 110, suitable fasteners 70 can be inserted through fastener holes 46 and 113 to effectively retain clamp plate 40 in position within groove 121 while effectively clamping plug 110 in place relative to fitting 120. By way of non-limiting example, fastener holes 113 could be tapped to receive fasteners 70 in the form of machine screws; alternatively, fastener holes 46 and 113 could be unthreaded to receive fasteners 70 in the form of bolts secured with nuts.

As shown in FIGS. 4 and 4A, flange 116 of plug 110 may optionally be formed with recesses or notches 114 to facilitate engagement of flange 116 with a wrench or other suitable tool to rotate plug 110 to break any bond that may form between bottom closure 119 of plug 110 and the plastic liner material during the tank-lining process. This is by way of example only, as flange 116 could be formed in a variety of other ways to facilitate tool engagement for this purpose (e.g., with an integral hex nut as illustrated for plug 10 in FIG. 1A).

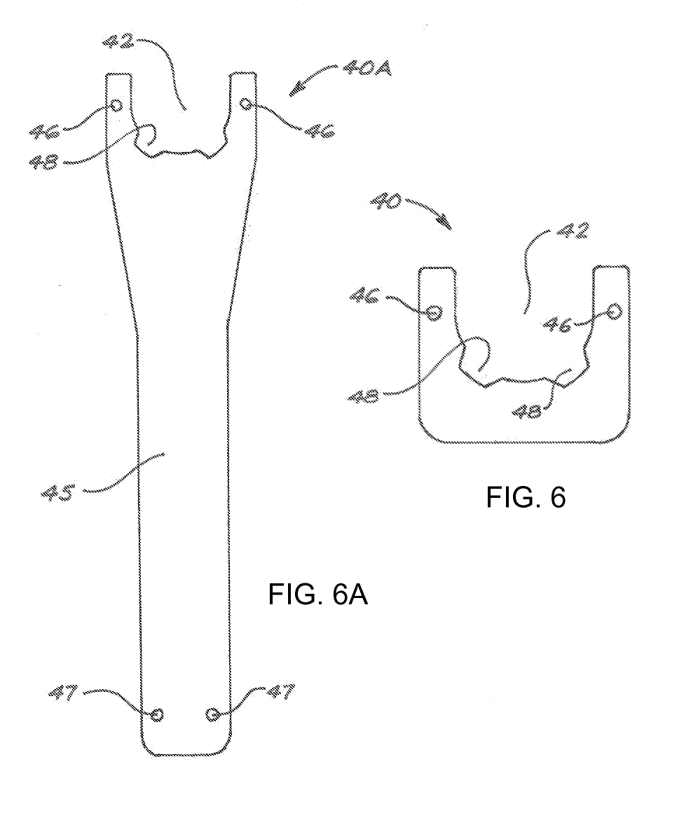

As shown in FIG. 6 and perhaps best appreciated with reference to FIG. 7A, cut-out 42 in clamp plate 40 preferably incorporates one or more notches 48 to enhance or facilitate uniform flow of heated air around the periphery of fitting 120 during the tank-lining process and thereby to mitigate the risk of cold spots.

FIG. 6A illustrates a clamp plate 40A in accordance with a variant embodiment. Variant clamp plate 40A is essentially the same as clamp plate 40 in FIG. 6 except that it has an extended tailpiece 45 with suitable mounting means (such as fastener holes 47 as illustrated, or any functionally-effective alternative mounting means, which could comprise mounting brackets or mounting lugs). Clamp plate 40A can thus be used to facilitate mounting of tank 50 to a supporting framework to be mounted onto a rotational molding machine, by means of suitable fasteners engaging fastener holes 47 in tailpiece 45 to connect clamp plate 40A the framework. When tank 50 has a sufficient number of fittings 120, it may be possible to mount tank 50 into the framework by way of clamp plates 40A alone, thus avoiding the need for alternative mounting means such as mounting lugs temporarily welded to the tank shell 51 (and perhaps marring any protective coatings or other finish treatments that may have been applied to the exterior surfaces of tank 50). Alternatively, one or more clamp plates 40A may be used to supplement other tank-mounting means.

### Detailed Summary of Exemplary Liner Molding Procedure

After all required or desired assemblies have been secured in corresponding openings in tank shell 51, tank 50 is placed into a suitable supporting framework which is then mounted onto a rotational molding machine. An appropriate amount of plastic is poured into the tank 50 through one of the fittings. Air fittings on the molding machine are strategically placed to blow air into the cavities 12 of temporary plugs 10. The tank 50 is then placed into an oven and the temperature is increased to a point at which the plastic start to melt. The tank 50 is rotated around an orthogonal axis, causing the liquid plastic to coat the inside surfaces of the tank wall 51 and the surfaces of exposed portions of temporary plugs 10 and fittings 20 projecting into tank 50.

This process is continued for an appropriate length of time to ensure complete melting of the plastic material and deposition onto the inner surface of tank shell 51 and onto exposed surfaces of the fitting assemblies. The tank 50 is then removed from the oven and, while still rotating around its orthogonal axis, it is allowed to air cool. It then proceeds into a cooling chamber where it is cooled to room temperature by suitable cooling methods (such as, but not limited to, by being sprayed with water cooling jets).

As the plastic material is cooled from liquid form back to a solid, it will shrink between 3% to 5%. This shrinkage of the plastic around the internally-protruding portions of the fitting assemblies forms a substantially liquid-tight seal.

Tank 50 is then removed from its supporting framework, and all temporary plugs 10 are removed from their corresponding fittings 20. As described previously, the portions of plastic liner that formed over the bottom closures 19 of the temporary plugs 10 can then be cut out or drilled out to allow fluid flow through flow passages 22 in fittings 20. After an appropriate inspection of the tank liner has been carried out, the tank 50 can be put into service.

It will be readily appreciated by those skilled in the art that various modifications of the present invention may be devised without departing from the scope and teaching of the present invention, including modifications which may use equivalent structures or materials hereafter conceived or developed. It is to be especially understood that the invention is not intended to be limited to any described or illustrated embodiment, and that the substitution of a variant of a claimed element or feature, without any substantial resultant change in the working of the invention, will not constitute a departure from the scope of the invention. It is also to be appreciated that the different teachings of the embodiments described and discussed herein may be employed separately or in any suitable combination to produce desired results.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element. Any form of the word “typical” is to be understood in the non-limiting sense of “common” or “usual”, and not as suggesting essentiality. Any use of any form of the terms “connect”, “engage”, “couple”, “attach”, or any other term describing an interaction between elements is not meant to limit the interaction to direct interaction between the subject elements, and may also include indirect interaction between the elements such as through secondary or intermediary structure. Relational terms such as “parallel”, “perpendicular”, “coincident”, “intersecting”, and “equidistant” are not intended to denote or require absolute mathematical or geometrical precision. Accordingly, such terms are to be understood as denoting or requiring substantial precision only (e.g., “substantially parallel”) unless the context clearly requires otherwise.

What is claimed is:

1. A fitting assembly comprising:
(a) a metallic fitting having an upper end, a lower end, and a perimeter wall defining a flow passage extending through the fitting between said upper and lower ends of the fitting, said fitting further having:
a.1 fitting support means for supporting the fitting in an opening in a metal shell such that a lower portion of the fitting will extend through the opening in the shell; and
a.2 fitting anchorage means associated with said lower portion of the fitting, for anchoring the fitting to a plastic liner applied to the lower surface of the metal shell;
(b) a plug having an upper end, a lower end, and a perimeter surface extending between said upper and lower ends of the plug, with said perimeter surface being configured to permit insertion of the plug into the fitting's flow passage through the upper end of the flow passage such that the lower end of the plug substantially closes off the lower end of the flow passage; and
(c) plug retention means, for removably retaining the plug within the flow passage of the fitting.

2. A fitting assembly as in claim 1 wherein the plug is generally cup-shaped, with an open-topped cavity bounded by the perimeter wall and a bottom closure.

3. A fitting assembly as in claim 1 wherein the plug has an annular flange limiting the depth to which the plug can be inserted into the flow passage of the fitting.

4. A fitting assembly as in claim 1 wherein an upper portion of the plug is configured for engagement with a tool whereby the plug can be rotated relative to the fitting.

5. A fitting assembly as in claim 1 wherein the perimeter wall of the fitting has a thickened upper portion extending radially outward, and wherein the fitting support means comprises a downward-oriented annular shoulder formed at the lower end of said thickened upper portion of the perimeter wall.

6. A fitting assembly as in claim 5 wherein the annular shoulder is recessed into the thickened upper portion of the perimeter wall.

7. A fitting assembly as in claim 1 wherein the fitting anchorage means comprises an annular flange projecting outward from a lower region of the fitting.

8. A fitting assembly as in claim 1 wherein the plug retention means comprises male threading formed on the perimeter surface of the plug, and mating female threading formed in the wall of fitting within the flow passage.

9. A fitting assembly as in claim 1 wherein the plug is non-rotatably retained within the flow passage of the fitting by means of splines formed on the perimeter wall of the plug and engageable with mating grooves formed in the wall of fitting within the flow passage.

10. A fitting assembly as in claim 5 wherein:
(a) the plug has an annular flange limiting the depth to which the plug can be inserted into the flow passage of the fitting, said annular flange having an extended portion that will extend beyond the perimeter of the thickened upper portion of the perimeter wall of the fitting when the plug is disposed within the fitting's flow passage;
(b) one or more fastener holes are formed through said extended portion of the plug's annular flange;
(c) an annular groove is formed into the outer surface of the perimeter wall of the fitting within the thickened upper portion thereof;
(d) the plug retention means comprises a clamp plate having a cut-out configured to permit mating engagement of the clamp plate within said annular groove on the fitting, said clamp plate having one or more fastener holes which are alignable with the one or more fastener holes in the extended portion of the plug's annular flange when the clamp plate is engaged within said annular groove, such that one or more fasteners can be installed in the aligned fastener holes in the annular flange and the clamp plate, thereby clamping the plug in place within the fitting and securing the clamp plate to the fitting.

11. A method of manufacturing a plastic-lined metal tank, said method comprising the steps of:
(a) providing a metal tank, said tank having a tank shell with an opening for receiving a fitting;
(b) providing a fitting assembly comprising a fitting and a plug, in accordance with claim 1, and mounting the fitting assembly in said opening in the tank shell such that a lower portion of the fitting extends through the opening in the shell;
(c) mounting the tank in a rotational molding apparatus;
(d) introducing a plastic material into the interior of the tank;
(e) applying heat to liquify the plastic material inside the tank;
(f) actuating the rotational molding apparatus to rotate the tank around an orthogonal axis, such that the liquefied plastic material coats the inside surfaces of the tank shell and portions of the plug and fitting projecting into the tank;
(g) while continuing to rotate the tank, allowing the tank to cool until the plastic material coating the inside surfaces of the tank has solidified;
(h) removing the plug from the fitting; and
(i) removing the solidified plastic material that formed over the bottom surface of the plug during the rotational molding process, such that fluid can flow through the flow passage in the fitting.

12. A method as in claim 11 wherein the plug is generally cup-shaped, with an open-topped cavity bounded by a plug perimeter wall and a bottom closure.

13. A method as in claim 11 wherein the plug has an annular flange limiting the depth to which the plug can be inserted into the flow passage of the fitting.

14. A method as in claim 11 wherein an upper portion of the plug is configured for engagement with a tool whereby the plug can be rotated relative to the fitting.

15. A method as in claim 11 wherein the perimeter wall of the fitting has a thickened upper portion extending radially outward, and wherein the fitting support means comprises a downward-oriented annular shoulder formed at the lower end of said thickened upper portion of the perimeter wall.

16. A method as in claim 15 wherein the annular shoulder is recessed into the thickened upper portion of the perimeter wall.

17. A method as in claim 11 wherein the fitting anchorage means comprises an annular flange projecting outward from a lower region of the fitting.

18. A method as in claim 11 wherein the plug retention means comprises male threading formed on the perimeter surface of the plug, and mating female threading formed in the wall of fitting within the flow passage.

19. A method as in claim 11 wherein the plug is non-rotatably retained within the flow passage of the fitting by means of splines formed on the perimeter wall of the plug and engageable with mating grooves formed in the wall of fitting within the flow passage.

20. A method as in claim 15 wherein:
(a) the plug has an annular flange limiting the depth to which the plug can be inserted into the flow passage of the fitting, said annular flange having an extended portion that will extend beyond the perimeter of the thickened upper portion of the perimeter wall of the fitting when the plug is disposed within the fitting's flow passage;
(b) one or more fastener holes are formed through said extended portion of the plug's annular flange;
(c) an annular groove is formed into the outer surface of the perimeter wall of the fitting within the thickened upper portion thereof; and
(d) the plug retention means comprises a clamp plate having a cut-out configured to permit mating engagement of the clamp plate within said annular groove on the fitting, said clamp plate having one or more fastener holes which are alignable with the one or more fastener holes in the extended portion of the plug's annular flange when the clamp plate is engaged within said annular groove, such that one or more fasteners can be installed in the aligned fastener holes in the annular flange and the clamp plate, thereby clamping the plug in place within the fitting and securing the clamp plate to the fitting.
